(19) United States
(12) Patent Application Publication
(10) Pub. No.: US 2019/0204350 A1
(43) Pub. Date: Jul. 4, 2019

(54) AUTOMATED SLIDE DROPPING SYSTEM

(71) Applicants: SADEEM Z.S. QDAISAT, BAYTOWN, TX (US); AIHAM Z.S. QDAISAT, BAYTOWN, TX (US); TAREQ Z.S. QDAISAT, BAYTOWN, TX (US)

(72) Inventors: SADEEM Z.S. QDAISAT, BAYTOWN, TX (US); AIHAM Z.S. QDAISAT, BAYTOWN, TX (US); TAREQ Z.S. QDAISAT, BAYTOWN, TX (US)

(21) Appl. No.: 16/329,648

(22) PCT Filed: Aug. 30, 2016
(86) PCT No.: PCT/US2016/049515

§ 371 Date: Feb. 28, 2019

(51) Int. Cl. G01N 35/10; G01N 35/00

(52) U.S. Cl. CPC G01N 35/1011; G01N 35/0099; G01N 2035/103; G01N 2035/00346; G01N 2035/00138

(57) ABSTRACT

The automated slide dropping system (100) includes components and subcomponents such as a multi-tube holder alloy metal rack (708) that permits the inclusion of more than one patient sample at a time; an angularly adjustable slide holder (702) divided into partitions; a 96-pipette tips or pipetting system plate (704) (instead of traditional bulb pipettes); a multiple-axis robotic arm (736); and a PC control unit and appropriate software. A liquid handling system (104) and a humidity/temperature controller (116) (118) are likewise provided as part of the testing system.

### TECHNICAL FIELD

The present invention relates generally to laboratory specimen testing systems, and more particularly to an automated slide dropping system that can be used for genetic testing of specimens.

### BACKGROUND ART

Genetic testing, including both cytogenetics and molecular genetics, is increasingly getting attention from the medical world due to higher accuracy in detecting, diagnosing, and accurately providing prognoses to patients for conditions in the field of oncology and for conditions of constitutional origin.

Unfortunately, the use of some cytogenetic testing is currently problematic due to the low mitotic index of patient samples using in vitro cultures. In order to overcome this low mitotic index criteria (low quality and quantity of cells that can be used for diagnosis), optimal slide dropping “good practice” should be taken into consideration for every patient sample. Current slide dropping techniques are subject to lack of temperature control in the buffer and sample cell suspension, and are slow.

Thus, an automated slide dropping system solving the aforementioned problems is desired.

### Disclosure of Invention

The automated slide dropping system includes such components and subcomponents as a multi-tube holder alloy metal rack that permits the inclusion of more than one patient sample at a time; an angularly adjustable slide holder divided into partitions; a 96-pipette tips or pipetting system plate (instead of traditional bulb pipettes); a multiple-axis robotic arm; and a PC control unit and appropriate software. A liquid handling system, as well as a humidity/temperature controller, is likewise provided as part of the testing system.

The automated slide dropping system provides the features of separating the slides by a divider between them to prevent splashing, modular units that can be more easily washed, dropping the fluid from a height to accomplish spread, dropping on a slide at an angle, and creating ideal conditions in the hood by heating water and having a fan to achieve more uniform moisture conditions, while allowing a total of 50-60 slides in a similar space.

These and other features of the present invention will become readily apparent upon further review of the following specification and drawings.

### BRIEF DESCRIPTION OF DRAWINGS

FIG. 1 is a block diagram of an automated slide dropping system according to the present invention.

FIG. 2 is a block diagram of the software and interface architecture of an automated slide dropping system according to the present invention.

FIG. 3 is a screenshot of the main window in the main user interface of an automated slide dropping system according to the present invention.

FIG. 4 is a screenshot of the deck tray window used to configure tip, deposit, samples and buffers of an automated slide dropping system according to the present invention.

FIG. 5 is a screenshot of the process parameters window of an automated slide dropping system according to the present invention.

FIG. 6 is a perspective view of an automated slide dropping system according to the present invention.

FIG. 7 is another perspective view of an automated slide dropping system according to the present invention.

FIG. 8 is a perspective view of a metal alloy slide holder of an automated slide dropping system according to the present invention.

FIG. 9 is a perspective view of the metal alloy slide holder slide-to-slide partition of an automated slide dropping system according to the present invention.

FIG. 10 is a perspective view showing the drive features of the robotic arm in an automated slide dropping system according to the present invention.

FIG. 11 is a perspective view showing the drive track of the robotic arm in an automated slide dropping system according to the present invention.

FIG. 12 is a perspective view showing the cog rail and brake of the robotic arm in an automated slide dropping system according to the present invention.

FIG. 13 is a perspective view showing the brake, cog, and motor of an automated slide dropping system according to the present invention.

FIG. 14 is a perspective view showing the syringe axis and system liquid tank of the automated slide dropping system according to the present invention.

Similar reference characters denote corresponding features consistently throughout the attached drawings.

### BEST MODES FOR CARRYING OUT THE INVENTION

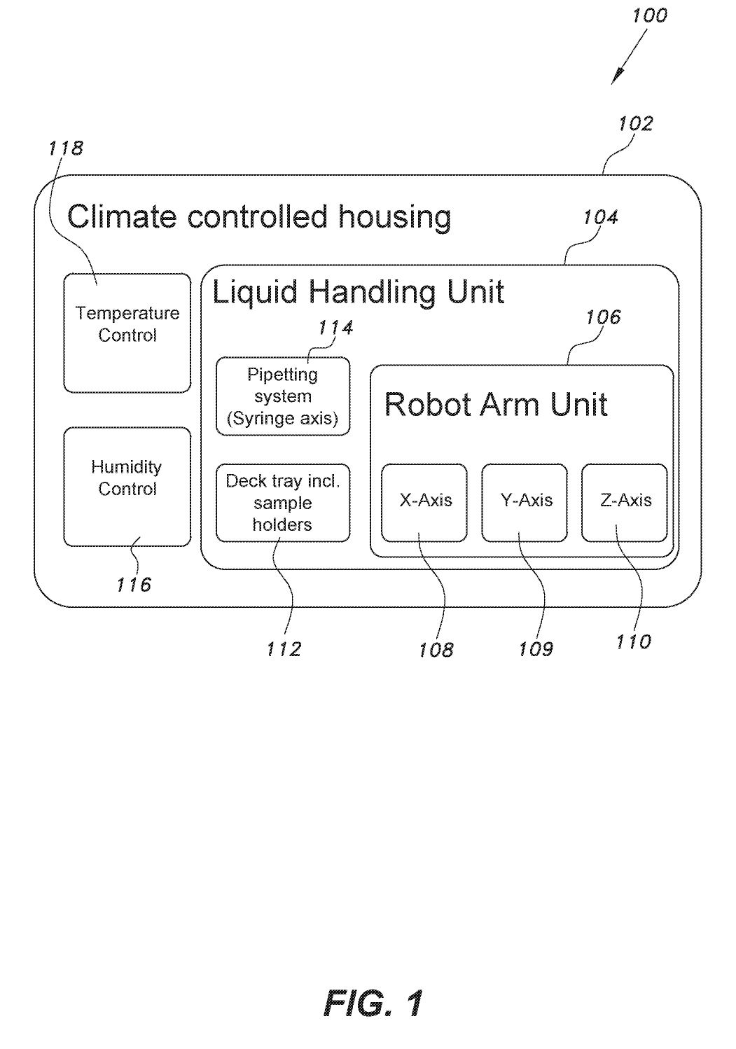

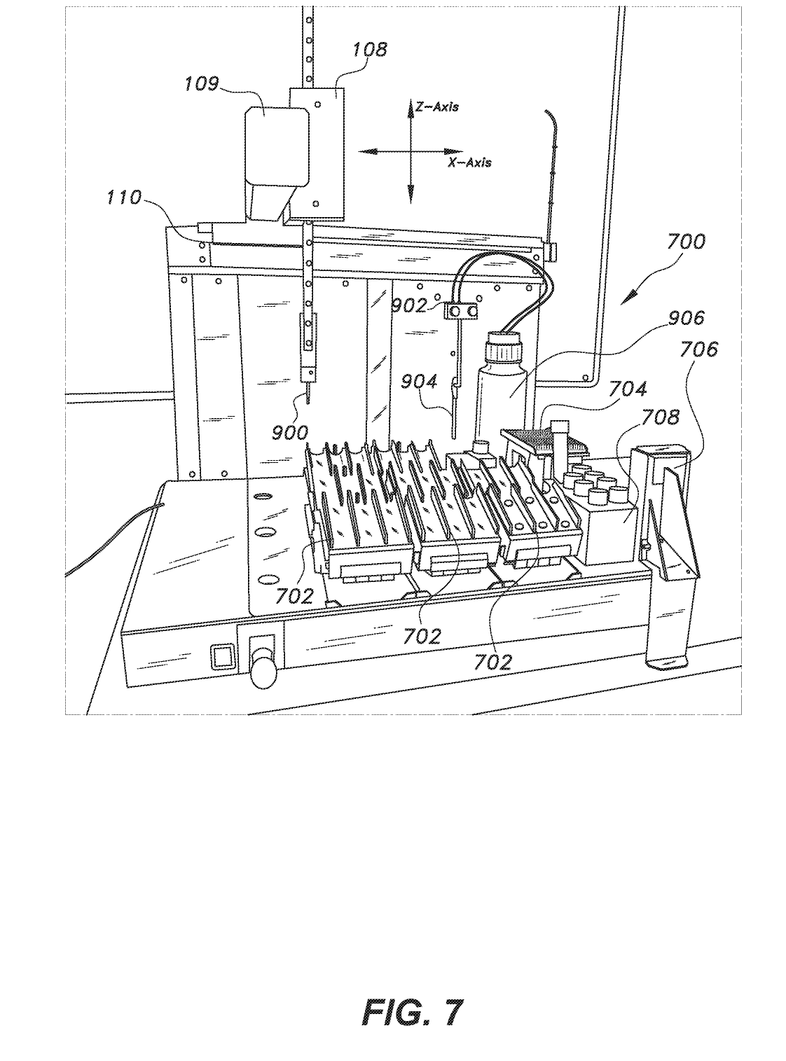

As shown in the block diagram of FIG. 1, the automated slide dropping system 100 is disposed in a climate-controlled housing 102. The climate-controlled housing 102 includes a humidity controller 116 and a temperature controller 118 for, inter alia, controlling slide temperature. A liquid handling unit 104 is disposed in the housing 102 and includes a deck tray and sample holder combination 112, and a syringe axis pipetting system 114. A robotic arm 106 is disposed in the liquid handling unit 104 and comprises an X-axis motor 108, a Y-axis motor 109, and a Z-axis motor 110 (also shown in FIG. 7).

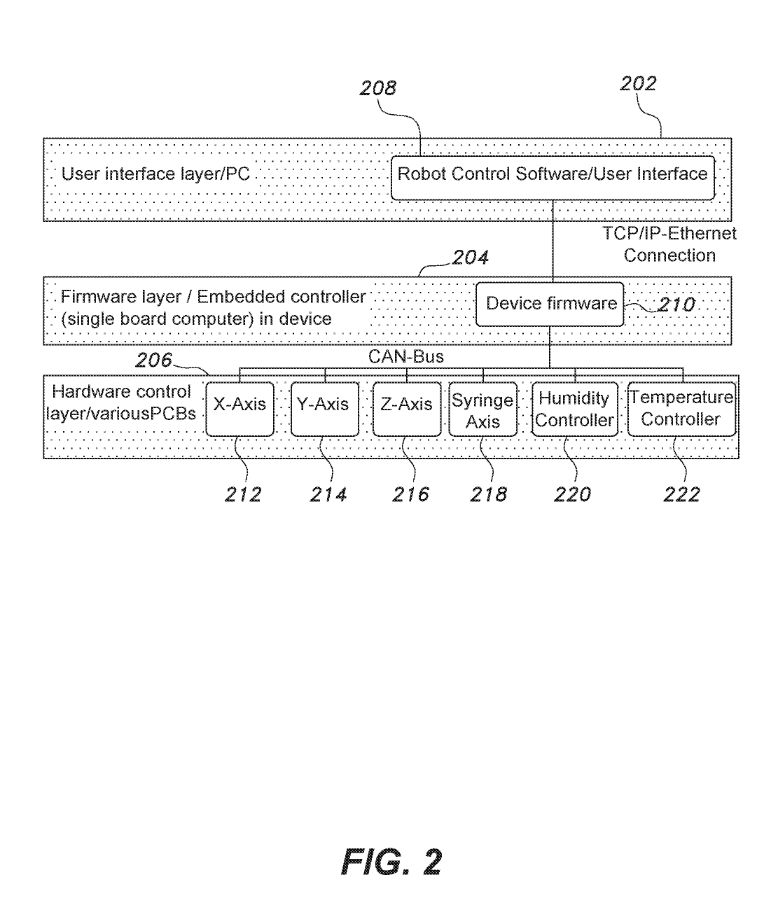

Software and interfacing (shown in FIG. 2) user interface layer/PC 202 includes robot control software/UI 208 in operable communication with the device firmware 210 via a TCP/IP-Ethernet connection. The device firmware 210 runs on a firmware layer/embedded controller (single-board computer) 204. In a hardware control layer 206, the device firmware 210 communicates via a CAN-bus with robotic X-axis controller 212, Y-axis controller 214, and Z-axis controller 216. Device firmware 210 also communicates with a syringe axis controller 218, a humidity controller 220, and a temperature controller 202 via the CAN-bus. The Robot Control software is programmed in Visual Basic 6, which is exemplary only. It should be understood that the Robot Control software may be programmed in any suitable programming language. The firmware components are programmed in C++, which is exemplary only. It should be understood that the firmware components may be programmed in any suitable programming language.

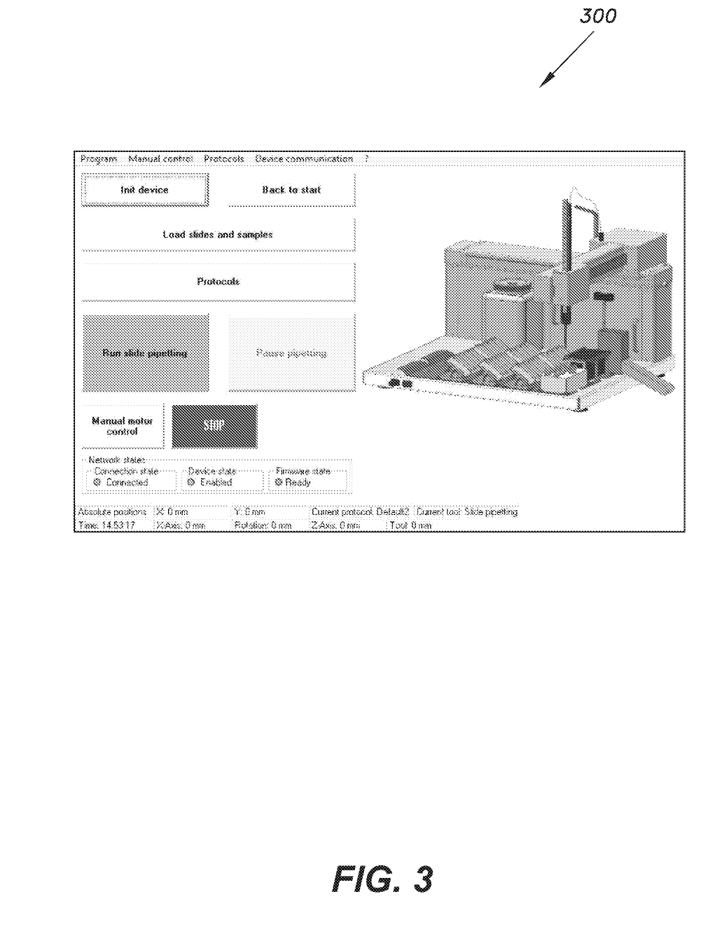

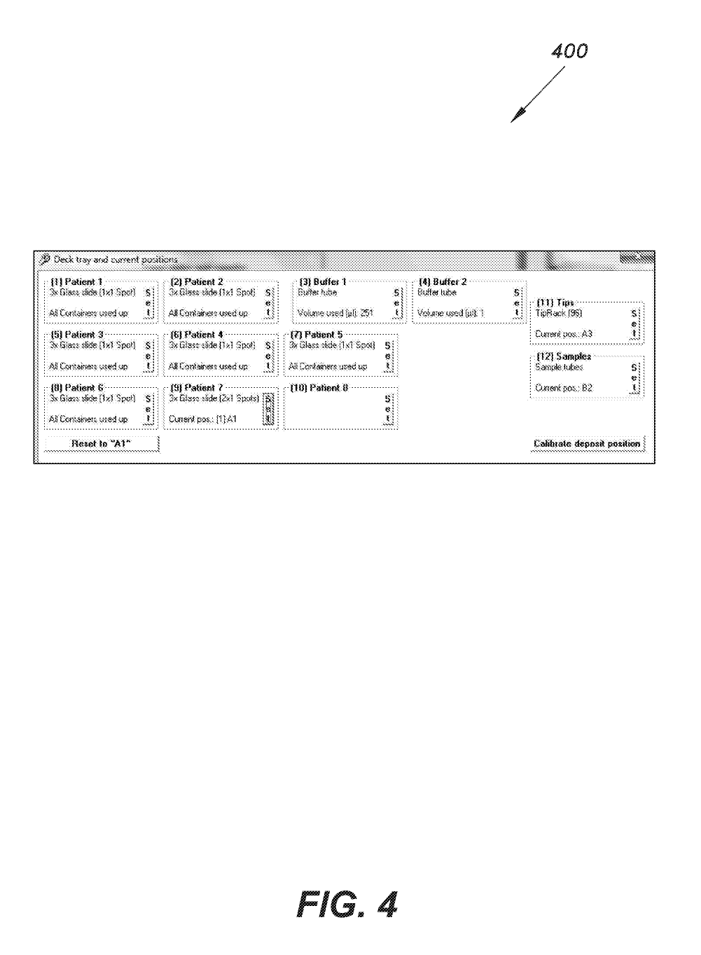

As shown in FIG. 3, the main window provides a main user interface 300 where the user sees the status of the robot and can initialize and start the device and monitor processes, such as “Init device”, “Load slides and samples”, “STOP”, “Run slide pipetting”, “Protocols”, “Manual motor control”, “Pause pipetting”, “Connection state”, “Device state”, and “Firmware state”. A Deck Tray window 400 (shown in FIG. 4) is presented for tip position, deposit position, sample and buffer configuration.

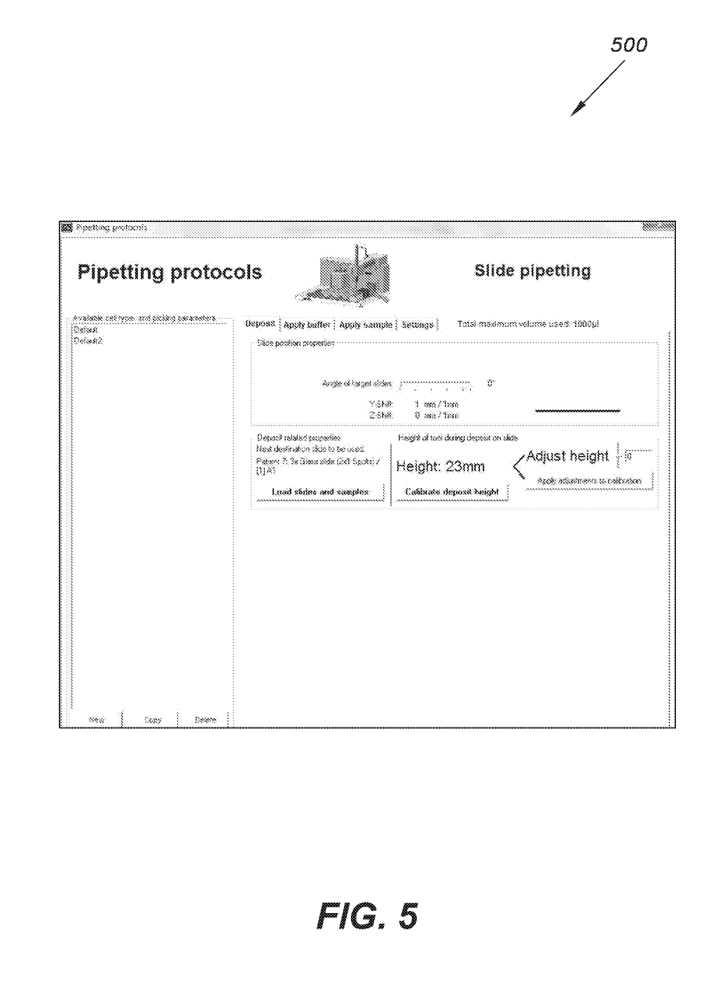

The Pipetting protocols 500 (shown in FIG. 5) is presented for adjustment, such as height of tool during deposit on slide, angle of the slide holders, or the like, according to hospital manual protocol.

Behind the user interface is an administrator that provides graphical process programming features where all the application scripts are defined. This is not done by the user, but is a system set up performed by a system administrator in a hospital for the first time. An Administrator allows the administrator to change the process on the fly if, for example, additional pipetting steps are necessary, or the like.

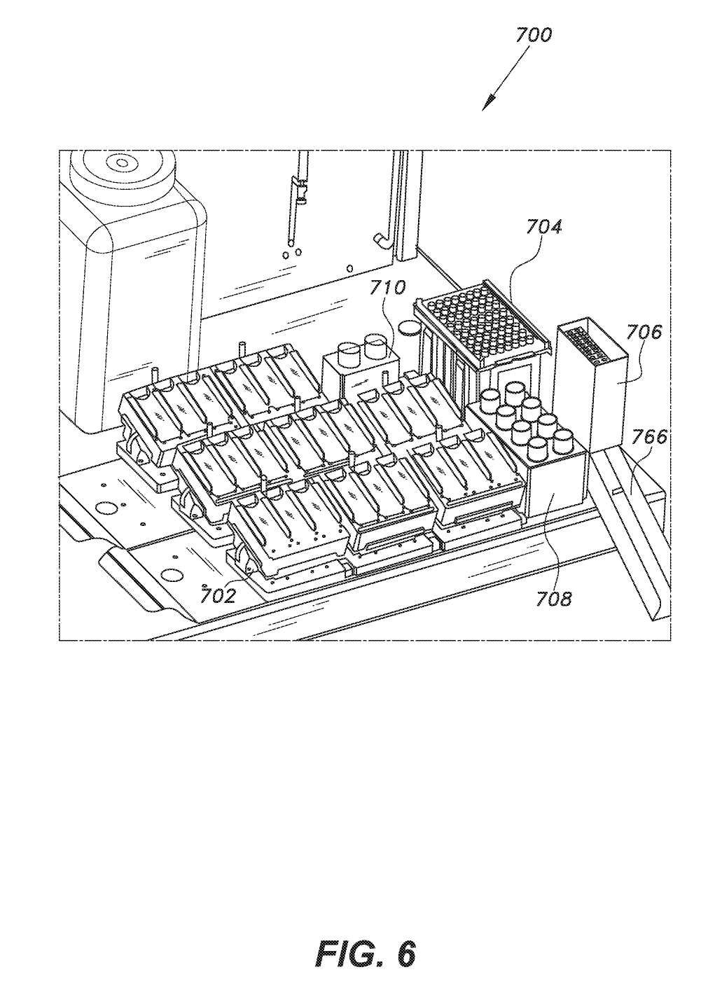

As shown in FIG. 6, a platform 700 disposed in the climate controlled housing facilitates automated slide dropping using a robotic arm 736 and liquid handling system 738 along with a tilted slide holder 702, a tip rack 704, and a buffer block comprising a liquid rack 710 disposed adjacent to the slide deck 702. The slide deck/holder 702 is preferably a metal alloy material. A tip drop and waste block 706 is disposed along an edge of the platform 700. A pipette tip waste chute 766 extends at a downward angle from the tip drop and waste block 706. A probe rack 708 is disposed between the tilted slide holders 702 and the tip drop and waste rack 706. The probe rack 708 is a multi-tube holder alloy metal rack that permits the inclusion of more than one patient sample at a time. Additionally, the tilted slide holders 702 are angularly adjustable and are divided into partitions. The tip rack 704 comprises a 96-pipette tips or pipetting system plate (instead of traditional bulb pipettes). FIG. 7 most clearly shows the robotic specimen delivery arm 900 attached to the z-, y-, and x-axis servo motors attached to the platform 700. The liquid delivery system includes a dispensing bottle 906, a dispensing conduit retaining bracket 902, and a dispensing syringe 904.

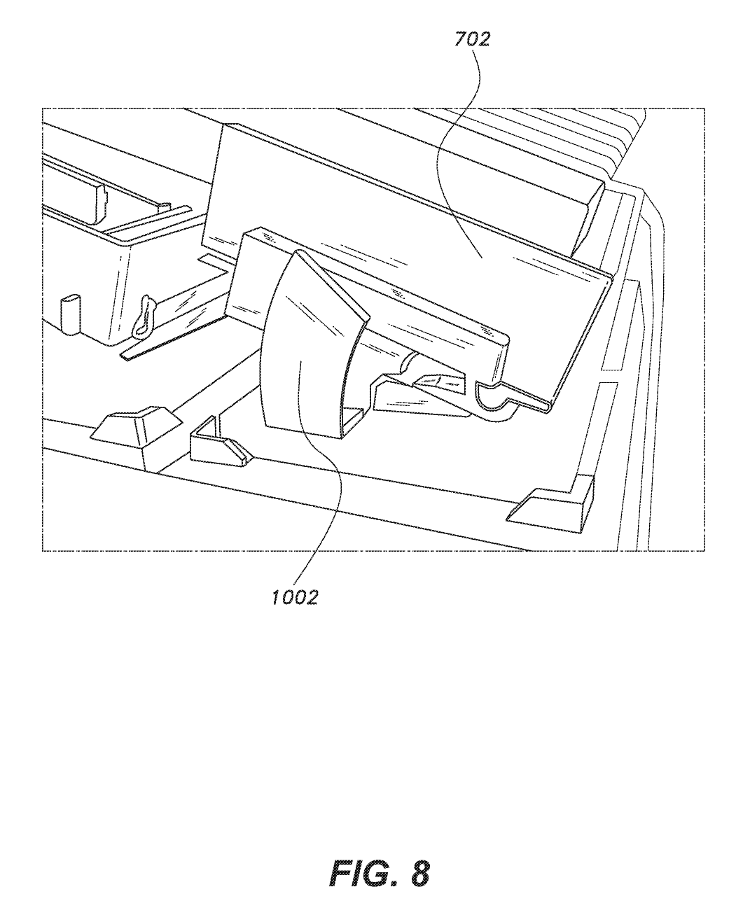

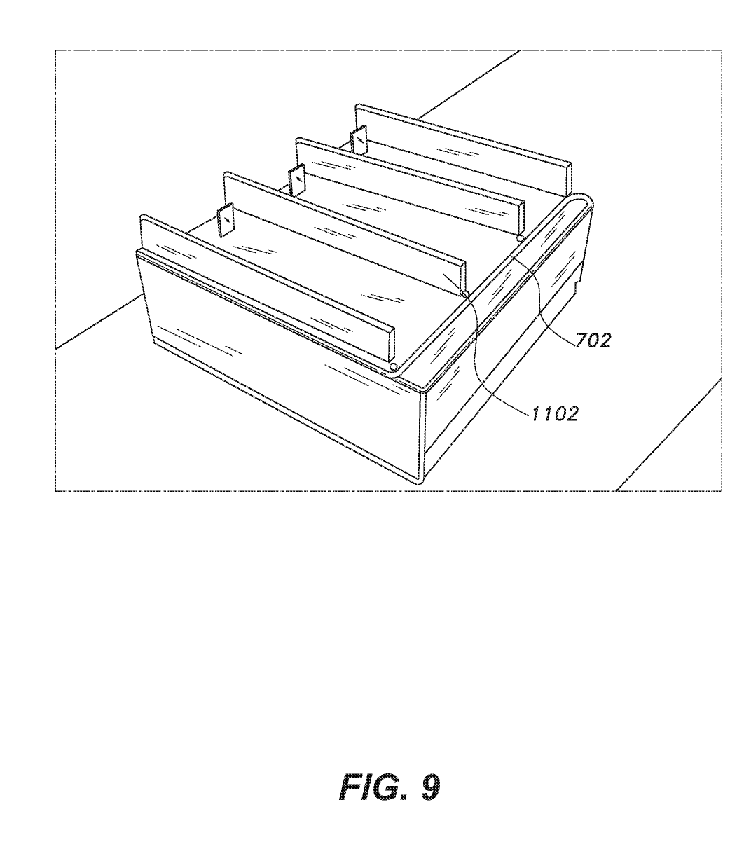

As shown in FIG. 8, an arcuate support arm 1002 is mounted to support and allow angular pivoting of the slide. As shown in FIG. 9, elongate planar partition walls 1102 extend upward from each slide to isolate the slide from any adjacent slide, thereby avoiding both inter-sample and intra-sample cross contamination.

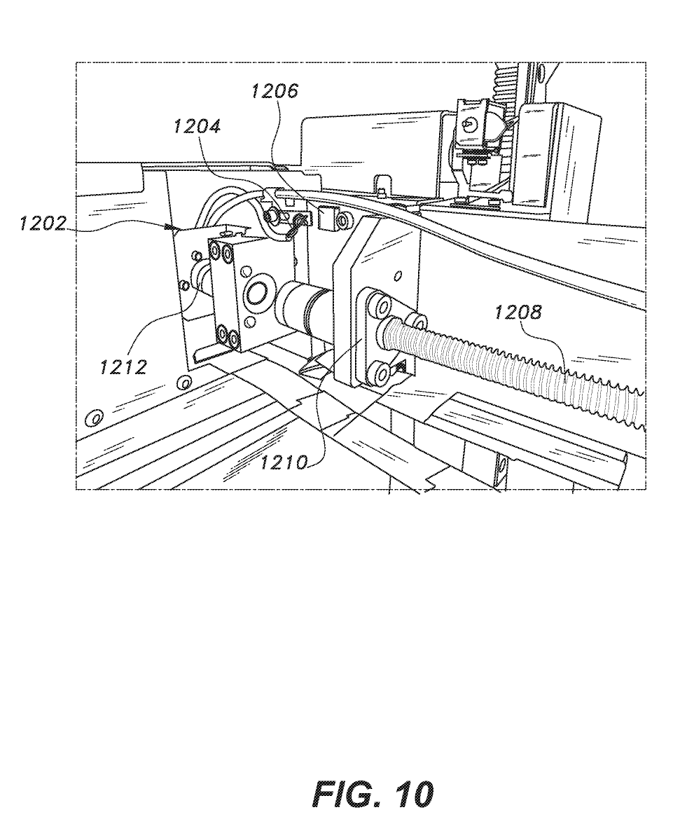

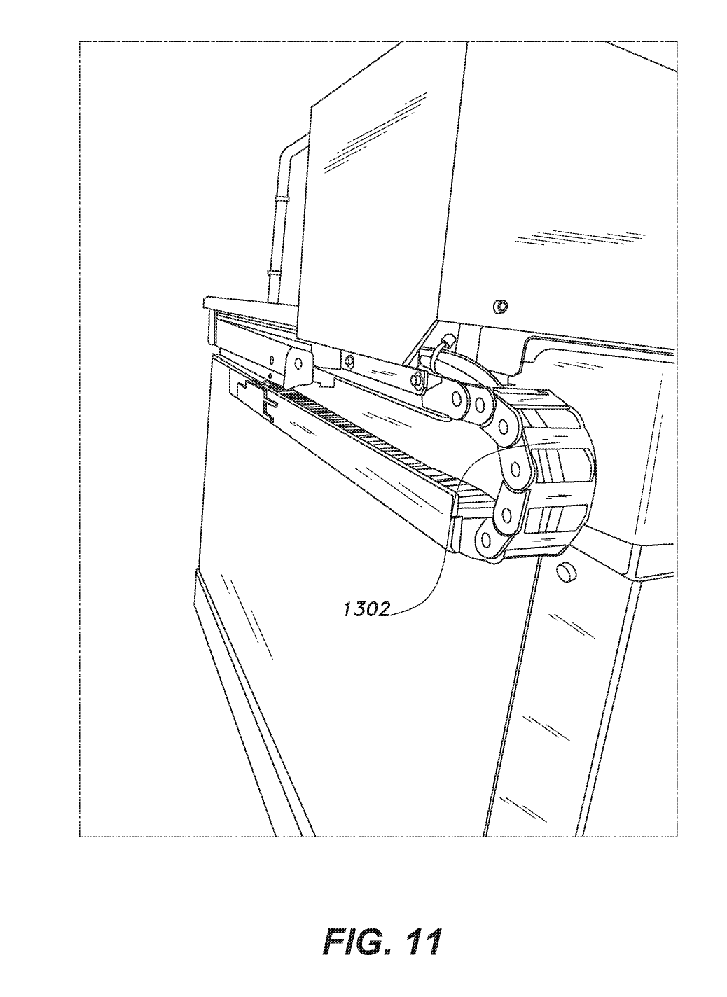

Referring now to FIG. 10, the two main axes (X and Y) are driven by servo motors, e.g., motor 1202, which are attached to the aforementioned platform 700. The motors drive a lead screw 1208 via, e.g., motor coupling 1212, that by turning causes movement in the x-direction (shown FIG. 7) of the load sitting on a ball spindle nut 1210 (the whole X-Arm moving left and right), and on it, the Y-arm (moving front and back). The two axes travel along ball-assisted guide rails. At the end of each rail are disposed magnetic limit sensors 1204 and an associated magnet 1206 to stop the hardware from moving too far. These sensors are also used to obtain a reference zero-position for each axis during device initialization. As shown in FIG. 11, the y-axis forward and back motion drive is a chain drive 1302.

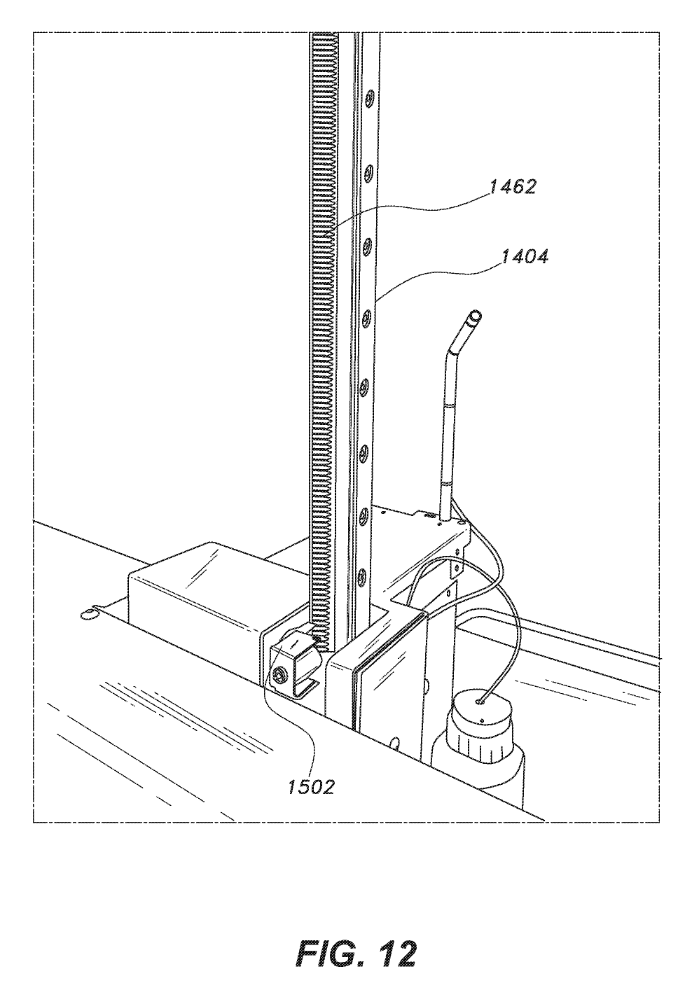

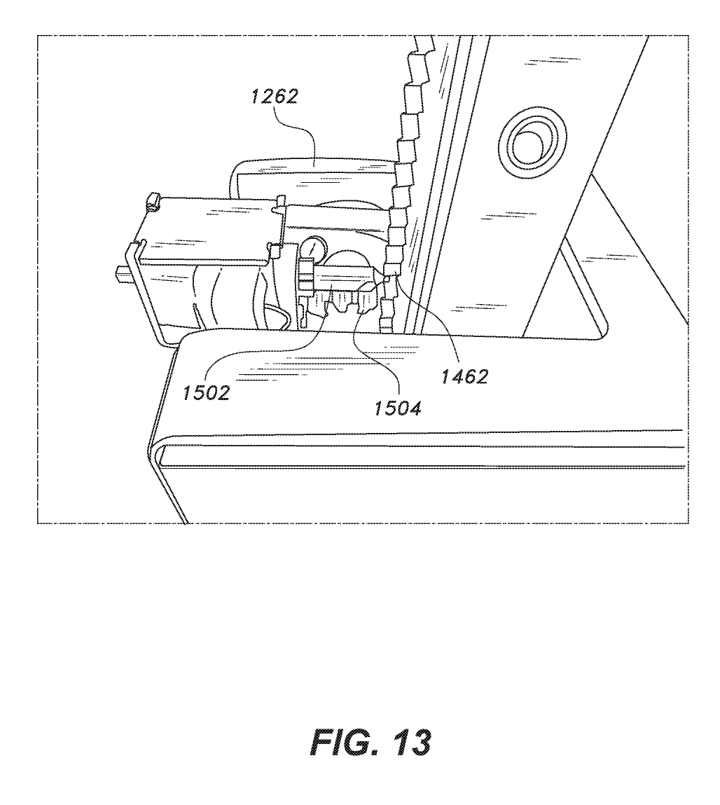

As shown in FIGS. 12 and 13, the Z-Axis is driven by motor 1262 using a gear or cog wheel 1504 that by rotating moves the Z-Axis up and down on a corresponding cog rail 1462 mounted on a vertically extending cog rail support 1404. There is an additional brake 1502 installed to prevent the Z-Axis from falling down when the motor 1262 does not hold the weight of the Z-Axis (e.g., during power down). Cables are disposed in cable guide rails to protect them from being damaged.

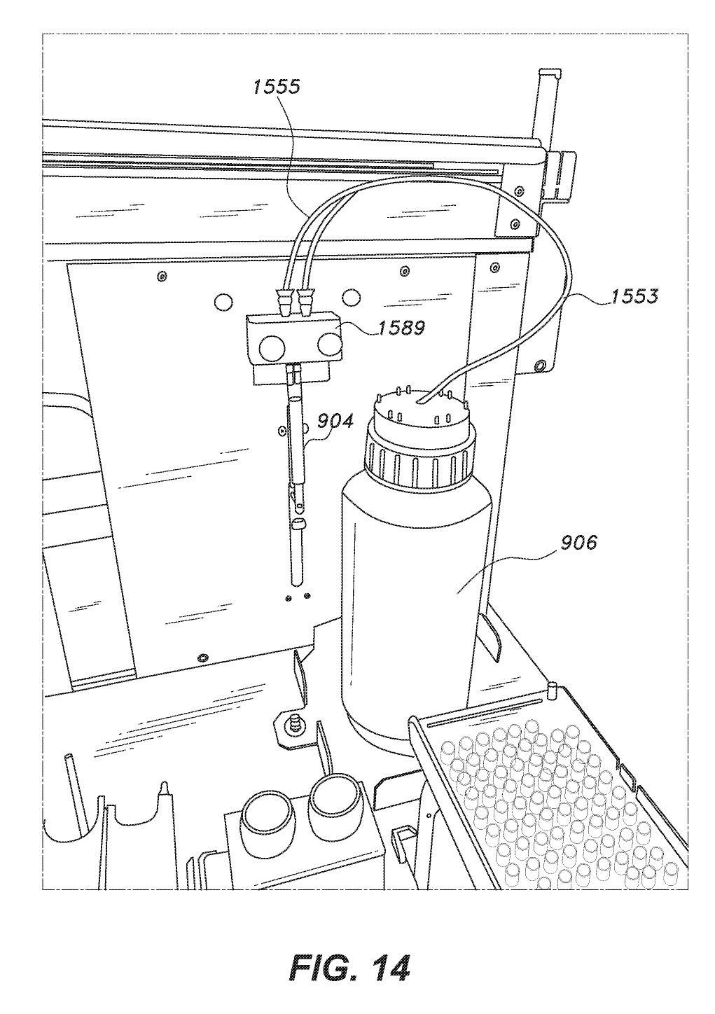

With respect to the liquid handling system shown in FIG. 14 (single channel only), the pump uses syringe 904 to aspirate and dispense liquid. The syringe 904 is connected to the tip adapter via valve 1589 using tubing 1555, and to the tip via valve 1589 using tubing 1553, which extends from the liquid tank 906. The syringe 904 is again driven by a servo motor connected to a lead screw with a ball spindle nut driving the syringe 904 up and down (from empty to full). At the end of the syringe 904, valve 1589 can switch between the system liquid tank 906 (used to fill the tubing with distilled water instead of air) and the tip adapter. By switching the valve to the system liquid tank 906, fresh water can be conveyed from the system liquid tank 906 into the syringe 904. By switching back to the tip adapter, air can be pushed out by pushing the fresh water towards the tip adapter. This is done during initialization of the system. By aspirating and dispensing with the motor-driven syringe 904, syringe 904 can be aspirated and liquid can be dispensed from the tip.

A medical technologist loads the samples cell suspension post harvesting in the system along with working buffer and labeled slides for each patient, adjusts parameters as needed or selects canned drop down protocol and clicks start. The robotic arm mixes the buffer and spreads a portion onto the slides to make them wet for better dropping quality, followed by mixing and dropping the patient sample (that both are in a multi-tube holder alloy metal rack, thereby allowing more than one patient sample per run). Dropping happens on the alloy metal slide racks that are angle-adjusted to add better dropping quality. This works as an Intra-system components Temperature/Humidity control.

The prototype includes the following hardware components: Robot Arm Pipetting system Deck tray, including buffer and sample tank holders, waste position and slide holders. Control unit (PC) Software components are: Motor controller firmware Device firmware Robot Control software, and user interface.

Regarding the Humidity/Temperature controller, the general principle is that air is pushed down through a HEPA-Filter using a fan sitting on top of the HEPA-Filter. This air is then brought into a laminar flow moving down through the device compartment, and is then recycled by moving back up in the back of the flow box. In front of the fan there is a heater that can heat the recycled air so that temperatures can be controlled up to 40° C. (˜28° C. is optimal, according to initial testing). Above the filter there is a humidifier based on sonication that can vaporize distilled water into the air that is then pushed through the HEPA-Filter. Both sides, as well as the front, can be opened using mechanical hinge doors. There is an additional sliding door in the front for sample loading. Whenever a door is opened, an exhaust fan starts to increase the airflow, hence making sure no contamination will reach the device through the open doors. Any contamination is immediately pulled down and then brought up to the fan compartment, where part of the air goes back towards the HEPA Filter and the excessive part of air goes to an exhaust opening. There is a flap at the exit of the exhaust that only opens when the doors open, so this and the two fan speeds (main fan in front of the HEPA-filter and exhaust fan in front of the exhaust) control how much air is pushed down and how much air is pushed out, hence controlling the total airflow when the doors are open. A humidity and temperature sensor inside the device compartment gives the input needed to adjust the function of the heating and the humidifier. This is controlled by embedded electronics that can be configured and supervised using a control panel with an LCD-Display and a couple of buttons.

The present system includes full humidity control, a controlled temperature, an extended height of slide dropping, an adjustable angle of slide dropping, full air flow control, dropping sample of a wet slide Buffer before dropping/wet, cooling of the sample using a metal alloy rack, buffer cooling utilizing a metal alloy rack, slide rack cooling utilizing a metal alloy rack, and a partition slide rack for separation between slides. Excess fluid control is achieved by tunneling in the slide rack. Disposal of the pipette tip is automated. Safest distance movement mitigates hovering over cross contamination. The number of per patient individual slide racks can be fifty-four, adjustable to two hundred eighty-eight (optional) slides, which facilitates a high speed (fast dropping) mechanism. A field barcode scanner is included. A touch screen is included for access to the aforementioned control pages.

It is to be understood that the present invention is not limited to the embodiments described above, but encompasses any and all embodiments within the scope of the following claims.

We claim:

1. An automated slide dropping system for use in genetic testing systems, comprising:
a platform disposed in a climate-controlled housing;
a humidity controller disposed in the climate-controlled housing;
a temperature controller disposed in the climate-controlled housing;
a slide deck tray and adjustably tilted partitioned slide holders, forming, in combination, a liquid handling unit disposed on the platform;
an X-Y-Z axes robotic arm including X-Y-Z servo-motors disposed on the platform;
a syringe attached to the X-Y-Z axes robotic arm;
a tip adapter attached to the X-Y-Z axes robotic arm, the tip adapter being in operable communication with the syringe;
a liquid rack forming a buffer block disposed adjacent to the slide deck tray;
a tip rack disposed adjacent to the slide deck tray;
a tip drop and waste block disposed along an edge of the platform;
a pipette tip waste chute extending at a downward angle from the tip drop and waste block;
a probe rack disposed between the adjustably tilted slide holders and the tip drop and waste rack; and
a system liquid tank disposed on the platform and in operable communication with the syringe.

2. The automated slide dropping system according to claim 1, wherein the probe rack is made of a metal alloy.

3. The automated slide dropping system according to claim 1, wherein the buffer block is made of a metal alloy.

4. The automated slide dropping system according to claim 1, wherein the tip rack holds pipette tips necessary for a procedure.

5. The automated slide dropping system according to claim 1, further comprising a valve having inputs fed by the tip adapter and the system liquid tank, and an output that feeds the syringe.

6. The automated slide dropping system according to claim 1, further comprising a controller connected to the X-Y-Z-axis servo-motors, tip adapter, syringe and slide angle actuators, the controller having means for mixing the buffer, for portion spreading onto the slides, and for angle adjustment of the slides for better dropping quality.

7. The automated slide dropping system according to claim 6, further comprising at least one magnetic limit switch and a corresponding magnet disposed on the platform, the limit switch and the magnet preventing excess travel of the robotic arm in at least one of the X-Y-Z axes.

8. The automated slide dropping system according to claim 7, further comprising:
a coupling connected to at least one of the X-Y-Z servo-motors;
a spindle nut disposed in the platform; and
a lead screw disposed through the ball spindle nut and connected to the coupling.

9. The automated slide dropping system according to claim 7, further comprising a chain drive connected to at least one of the X-Y-Z servo-motors.

10. The automated slide dropping system according to claim 7, further comprising:
a cog wheel connected to at least one of the X-Y-Z servo-motors; and
a corresponding cog rail in operable communication with the cog wheel.

11. The automated slide dropping system according to claim 10, further comprising a brake in operable communication with the cog rail.

12. The automated slide dropping system according to claim 7, further comprising a CAN-bus in operable communication with the controller to facilitate communication between the controller and the X-Y-Z servo-motors, tip adapter, syringe slide angle actuators, humidity controller and temperature controller.

13. The automated slide dropping system according to claim 7, further comprising a slide angle actuator in operable communication with the adjustably tilted partitioned slide holders, the slide angle actuator adjusting the slide angle automatically.

14. The automated slide dropping system according to claim 7, further comprising a field barcode scanner.

15. The automated slide dropping system according to claim 7, further comprising a temperature controller that controls temperature of the slide.
